(19) United States
(12) Patent Application Publication
(10) Pub. No.: US 2013/0063412 A1
(43) Pub. Date: Mar. 14, 2013

(54) ELECTRONIC DEVICE AND DRIVING METHOD OF THE ELECTRONIC DEVICE

(71) Applicant: Kenichi Ide, Kodaira-shi (JP)

(72) Inventor: Kenichi Ide, Kodaira-shi (JP)

(21) Appl. No.: 13/460,410

(22) Filed: Apr. 30, 2012

(30) Foreign Application Priority Data
Sep. 12, 2011 (JP) 2011-198800

(51) Int. Cl. G09G 5/00

(52) U.S. Cl. 345/212

(57) ABSTRACT

According to one embodiment, an electronic device including, an emergency power supply module configured to supply electric power to the display at the time of interruption of a regular power supply, a first communication module configured to perform communication based on a first standard, a second communication module configured to perform communication based on a second standard having a capacity and a transmission speed that are lower than those of the first standard, and a controller configured to drive a display using the emergency power supply module and to switch the communication using the first communication module to the communication using the second communication module.

### CROSS-REFERENCE TO RELATED APPLICATIONS

This application is based upon and claims the benefit of priority from prior Japanese Patent Application No. 2011-198800, filed Sep. 12, 2011, the entire contents of which are incorporated herein by reference.

### FIELD

Embodiments described herein relate generally to programs and others which are received through space waves or a network, an electronic device which uses near field communication and the like to acquire and reproduce information different from programs that can be received through spaces waves or a network, and a driving method of the electronic device.

### BACKGROUND

In viewing apparatuses and viewing methods for receiving and reproducing a program (content) supplied by a broadcasting station (broadcasting organization) or a distributor, a viewing apparatus and a viewing method that acquire and reproduce information and others different from the program (content) using near field communication and the like have been put to practical use.

It is needless to say that viewing a program (content) and reproducing information acquired by near field communication and the like cannot be performed in a viewing apparatus which operates using an external power supply alone when a major power outage or the like occurs.

Although a viewing apparatus provided with a battery (an internal power supply/emergency power supply) has been also put to practical use, an operable (viewable) time is limited due to a battery (emergency power supply) capacity.

In particular, in case of providing information by near field communication and the like, if an information providing side does not have sufficient operating time, a final viewable time becomes small even though the viewing apparatus has sufficient operable time.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing an example of a viewing apparatus to which an embodiment is applied and a device connected to the viewing apparatus according to an embodiment;

FIG. 2 is an exemplary diagram showing an example of a viewing apparatus to which an embodiment is applied according to an embodiment;

FIG. 3 is an exemplary diagram showing an example of a device connected to the viewing apparatus to which an embodiment is applied according to an embodiment;

FIG. 4 is an exemplary diagram showing an example of a selecting operation (switching communication between the viewing apparatus and the device connected to the viewing apparatus) of a communication unit to which an embodiment is applied according to an embodiment;

FIG. 5 is an exemplary diagram showing an example of a selecting operation (interchanging electric power between the viewing apparatus and the device connected to the viewing apparatus) of a power supply to which an embodiment is applied according to an embodiment;

FIG. 6 is an exemplary diagram showing an example of a power interchange line to which an embodiment is applied according to an embodiment; and

FIG. 7 is an exemplary diagram showing an example of interchange of electric power between the viewing apparatus and the device connected to the viewing apparatus to which an embodiment is applied according to an embodiment.

### DETAILED DESCRIPTION

Various embodiments will be described hereinafter with reference to the accompanying drawings. In general, according to one embodiment, an electronic device comprising: a display; an emergency power supply module configured to supply electric power to the display at the time of interruption of a regular power supply; a first communication module configured to perform communication based on a first standard; a second communication module configured to perform communication based on a second standard having a capacity and a transmission speed that are lower than those of the first standard; and a controller configured to drive the display using the emergency power supply module and to switch the communication using the first communication module to the communication using the second communication module if the regular power supply is interrupted.

Embodiments will now be described hereinafter in detail with reference to the accompanying drawings. It is to be noted that elements or structures described below may be realized by hardware or realized by software by use of a microcomputer (central processing unit [CPU]), i.e., a processor or the like.

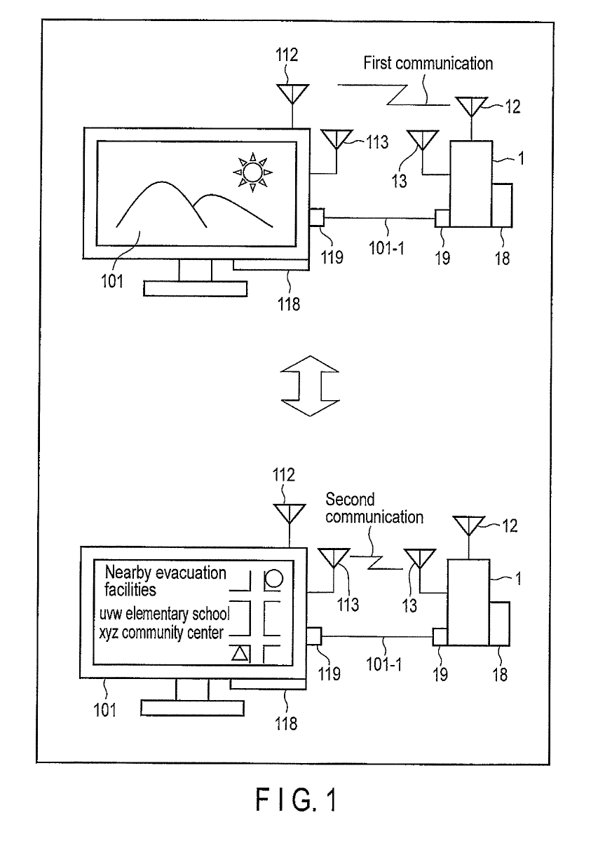

FIG. 1 shows an example of a viewing apparatus to which an embodiment is applied and devices connected to the viewing apparatus.

A viewing apparatus 101 is a so-called television set (television receiver) that reproduces a program (content) acquired through space waves or a network. It is to be noted that various available forms and operation methods of the viewing apparatus 101 can be used, and enabling operations using any power supply other than a non-commercial power supply can suffice, which will be described later. Further, the viewing apparatus 101 may be, e.g., an apparatus obtained by integrally combining a monitor device (display) and a set-top box (STB, which means an external tuner device in a broad sense or means a brancher or the like installed by a content distributer in a narrow sense), or a personal computer (PC).

A viewing apparatus (television set) 101 can transmit/receive data to/from a data storage apparatus 1 through wireless communication or a network, and reproduces data held by in the data storage apparatus 1. It is to be noted that the data storage apparatus 1 is, e.g., a network attached storage (NAS) and includes a high-capacity hard disk (HDD) and an Internet Protocol (IP) communication means. It is to be noted that the viewing apparatus 101 and the data storage apparatus 1 are connected to each other by a later-described power transmission path (power interchange line) 101-1 independently from transmission/reception of data. Further, as different from a home (small office home office) power line defined by power line communication (PLC), the power transmission path 101-1 is intended for interchange of power between a power supply transmission/reception module 119 (which will be described later) of the viewing apparatus 101 and a power supply transmission/reception module 19 (which will be described later) of the data storage apparatus 1. It is to be noted that, as to the interchange of power between the viewing apparatus 101 and the data storage apparatus 1, electric power can be also transmitted wirelessly (contactless; contactless is written because, for example, a reception-side device is mounted on a transmission-side device without using a plug or a connector, or both the devices are placed in a power supply area in the range of a fixed distance).

The viewing apparatus 101 and the data storage apparatus 1 can process digital information (program) obtained by encoding audio/video content or various kinds of data such as text data like characters or picture data based on, e.g., Moving Picture Experts Group (MPEG)-1, -2, -4 (H. 264/AVC) for video; MPEG Audio Layer-3 (MP3), Audio Codec 3 (AC3), or linear pulse code modulation (PCM) for audio; or Joint Photographic Experts Group (JPEG) for still pictures.

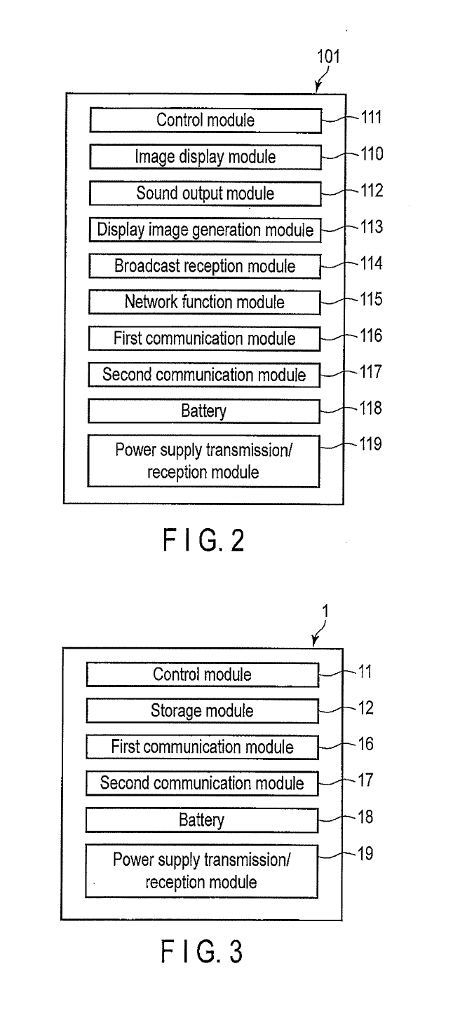

As schematically shown in FIG. 2, the viewing apparatus 101 comprises at least an image display module 110, a control module 111, a sound output module 112, a display image generation module 113, a broadcast reception module 114, a network function module 115, a first communication module 116, a second communication module 117, a battery (an own power supply, i.e., non-external power supply module) 118, and the power supply transmission/reception module 119. It is to be noted that the viewing apparatus (television set) 101 can perform not only operations using an external power supply, e.g., a so-called commercial power supply provided by an electric power company but also operations using a built-in non-external power supply, e.g., a battery (which will be referred to as an own power supply hereinafter) 118 which will be described later. Further, the own power supply (battery) 118 can supply electric power (an output) corresponding to a predetermined ratio with respect to an external device, e.g., the data storage apparatus 1.

The control module 111 execute various kinds of control over the viewing apparatus 101.

A speaker is used as the sound output module 112. Output terminals for an external output member, e.g., a headphone may be prepared as a matter of course.

The display image generation module 113 converts a moving picture or a still picture supplied from the broadcast reception module 114 or the network function module 115 into a signal in a format that can be processed by the image display module 110.

The broadcast reception module 114 receives a television broadcast provided by, e.g., a broadcasting organization or executes decoding processing for data of a sound/picture/data broadcast acquired through a distributer as typified by a cable television or a network connected to a supply source or the like that enables accessing content stored in a server and others.

The network function module 115 generates a signal in a format that can be processed by the display image generation module 113 or the sound output module 112 from data of, e.g., a sound/video/text/still picture held by the data storage apparatus 1 through the first communication module 116 or the second communication module 117 in a local area network (LAN which is mainly a relatively small network at home or in a building).

The first communication module 116 is based on, e.g., the WiFi (Institute of Electrical and Electronics Engineering [IEEE] 802.11 [a/b/g/n]) standard, and it is a communication module which can perform wireless communication of up to 300 Mbps in a 5- (5.2-) or 2.4-GHz band between devices conforming to the same standard. The first communication module 116 can perform transmission at a relatively high bit rate, e.g., streaming transmission of audio content or video content.

The first communication module 116 is used as communication means when an AC power supply which is a regular power supply of this viewing apparatus 101 can be used, and it is used for not only transmission of the audio content or video content but also transmission of various kinds of data, e.g., picture data or text data.

The second communication module 117 is, e.g., Bluetooth (registered trademark). Bluetooth is based on the IEEE 802.15.1 standard, and it is a communication module that can be perform wireless communication of 1 Mbps in a 2.4-GHz band in a conventional version. It is to be noted that this communication module has a limit (class) in an output (radio field intensity) and a range and can perform communication in 100 m (meters) as a maximum output. Further, although versions have no compatibility with each other, but a version 4.0 enables communication of 24 Mbps.

The second communication module 117 is characterized in that its speed is lower than that of the first communication module 116 but its consumption power is small.

The second communication module 117 is used as communication means when the AC power supply as the regular power supply of this viewing apparatus 101 cannot be used, and it transmits content such as text data like characters or picture data that can be practically transmitted at a relatively low bit rate. For example, when a power outage occurs due to heavy rain or a typhoon, acquiring information of, e.g., evacuation facilities in the neighborhood is desired, and such information can be acquired (by the viewing apparatus 101) from the data storage apparatus 1 through the second communication module when the communication means has been switched to the second communication module 117 from the first communication module 116 due to a power outrage.

The battery (own power supply/non-external power supply module) 118 is a standby (emergency) power supply of the viewing apparatus 101, and it is used for driving the viewing apparatus 101 when the AC power supply (external power supply) which is a regular power supply cannot be used. The battery 118 can also supply the electric power to the data storage apparatus 1 through the later-described power supply transmission/reception module 119 and the power transmission path 101-1 when this battery has sufficient supply capability.

The power supply transmission/reception module 119 is an interface for power transmission which is used for interchanging the electric power with the data storage apparatus 1.

As schematically shown in FIG. 3, the data storage apparatus 1 comprises at least a control module 11, a storage module 12, a first communication module 16, a second communication module 17, a battery (an own power supply, i.e., non-external power supply module) 18, and the power supply transmission/reception module 19.

The control module 11 carries out various kinds of control over the data storage apparatus 1.

The storage module 12 holds data of content that can be reproduced by the viewing apparatus 101, i.e., various kinds of data such as audio/video/text/still picture data. The data of various kinds of content held (stored) in the storage module 12 is transmitted to the viewing apparatus 101 through the first communication module 16 or the second communication module 17 which is described below.

The first communication module 16 is a WiFi communication module that can perform WiFi communication with the first communication module 116 of the viewing apparatus 101.

The second communication module 17 is a communication module that can perform communication based on Bluetooth with the second communication module 117 of the viewing apparatus 101. The second communication module 17 carries out the communication based on Bluetooth on behalf of the first communication module 16 with the second communication module 117 of the viewing apparatus 101 when the AC power supply which is the regular power supply of the data storage apparatus 1 cannot be used.

The first communication module 16 is used as communication means when the AC power supply (external power supply) which is the regular power supply of the data storage apparatus 1 can be used.

The battery 18 is a standby (emergency) power supply of the data storage apparatus 1, and it is provided for driving the data storage apparatus 1 when the AC power supply which is the regular power supply cannot be used. The battery 18 can also supply the electric power to the viewing apparatus 101 when this battery has sufficient supply capability.

The power supply transmission/reception module 19 is an interface for power transmission which is used for interchanging the electric power with the viewing apparatus 101.

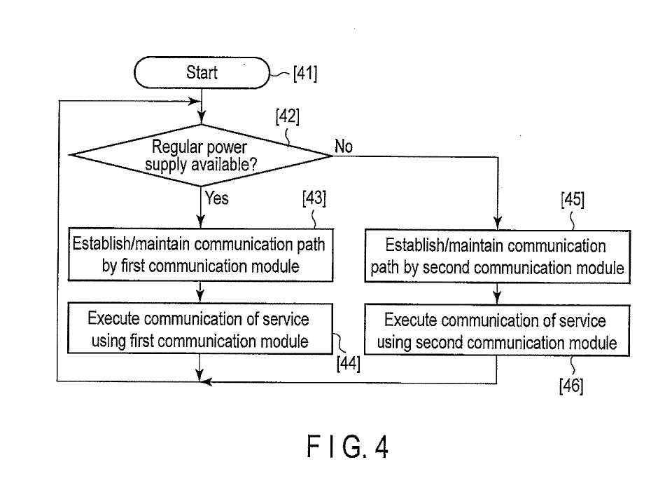

FIG. 4 illustrates an example of a selecting operation of the communication module, i.e., switching communication between the viewing apparatus and a device connected to the viewing apparatus.

This flowchart (shown in FIG. 4) is used in both the viewing apparatus 101 and the data storage apparatus 1 in this embodiment. A description will be given from the standpoint of the viewing apparatus 101.

The viewing apparatus 101 is started (block 41).

Whether the regular power supply can be used is determined (block 42). When the regular power supply can be used (block 42-YES), a communication path with respect to the data storage apparatus 1 is established or maintained (when a first communication path has been already established) by the first communication module 116 (block 43), and the communication of a service using the first communication module 116 is carried out (block 44). The service using the first communication module 116 is a service for reproducing all kinds of content such as audio/video/text/still pictures.

When the service using the first communication module 116 (block 44) is finished, whether the regular power supply can be used (at the start of a next service) is again determined (block 42).

On the other hand, when the regular power supply cannot be used (block 42-NO), a communication path is established or maintained (when a second communication path has been already established) by the second communication module (block 45).

Then, communication of a service using the second communication module 117 is carried out (block 46). The service using the second communication module 117 is a service for reproducing content such as text/still pictures that can be practically transmitted even in a transmission path of a low bit rate.

When the service using the second communication path 117 (block 46) is finished, whether the regular power supply can be used (at the start of a next service) is again determined (block 42). It is to be noted that, as a matter that is common to block 43 and block 45, when the type of communication module that has been already utilized is changed, the communication path of the utilized communication module is disconnected, and then the communication path is then established by the communication module that is newly utilized. That is, the first communication module or the second communication module is selectively switched based on whether the regular power supply can be used.

When the regular power supply can be used, communication connection with the data storage apparatus 1 does not have to be necessarily established or maintained by the first communication module 116. That is, the viewing apparatus 101 may control the communication connection/disconnection with respect to the data storage apparatus 1 by using the first communication module 116 or the second communication module 117 in response to, e.g., an operation from a user when the regular power supply can be used, and it may carry out the communication connection using the second communication module 117 when the regular power supply cannot be used.

Furthermore, when the regular power supply cannot be used, the viewing apparatus 101 may transmit to the data storage apparatus 1 an instruction for maintaining an activated state of the second communication module 17 and stopping (limiting) operations of other modules. It is to be noted that the instruction may be transmitted by the first communication module 116 and or may be transmitted by the second communication module 117. That is, after the regular power supply is disabled, the instruction may be transmitted by the first communication module 116 before switching to the second communication module 117 from the first communication module 116, or the instruction may be transmitted by the second communication module 117 after switching to the second communication module 117 from the first communication module 116. Moreover, the data storage apparatus 1 maintains the supply of the electric power to the second communication module 17 and limits the supply of the electric power to other modules in accordance with the instruction.

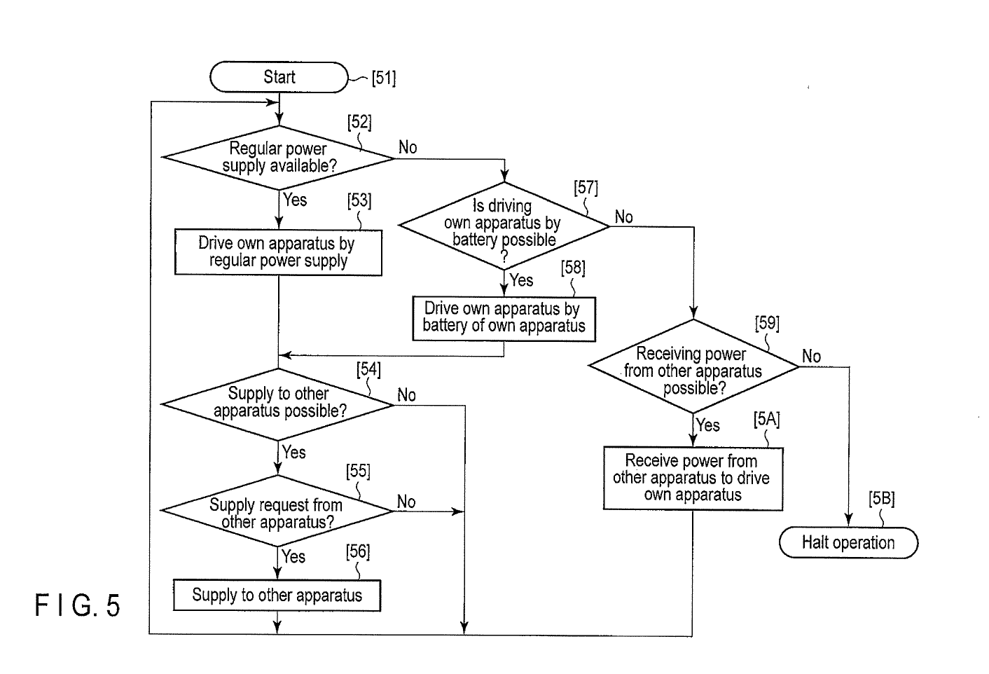

FIG. 5 shows a power supply switching operation, i.e., switching the power supply in each of the viewing apparatus and the device connected to the viewing apparatus and an example of interchange of the electric power between both the apparatuses.

This flowchart (shown in FIG. 5) is used in both the viewing apparatus 101 and the data storage apparatus 1 in this embodiment. A description will now be given from the standpoint of the viewing apparatus 101.

The viewing apparatus 101 is started (block 51).

Whether the regular power supply can be used is determined (block 52). When the regular power supply can be used (block 52-YES), the viewing apparatus 101 (own apparatus) is driven by the regular power supply (block 53).

Subsequently, a determination is made upon whether the power supply has available capacity for supplying the electric power to the connected device on the other side, i.e., the data storage apparatus 1 (other apparatus) (block 54). If the electric power can be supplied (block 54-YES), whether the other apparatus has a supply request (whether the other apparatus is requesting the supply of the electric power) is determined (block 55). The supply request is made through the communication path established by either the first communication module 116 or the second communication module 117.

When the supply request is made (block 55-YES), the electric power is supplied to the data storage apparatus 1 (other apparatus) (block 56). Then, whether the regular power supply can be used includes a situation that the power supply does not have available capacity for supplying the electric power to (other apparatus) in block 54 [NO] and a situation that (other apparatus) does not request the supply of the electric power in block 55 [NO], and whether the regular power supply can be used is again determined (block 52).

On the other hand, when it is determined that the regular power supply cannot be used (block 52-No), a determination is made upon whether driving can be performed using the battery 118 of the viewing apparatus 101 (own apparatus) (block 57), and the driving is carried out using the battery 118 of the viewing apparatus 101 (own apparatus) (block 58) if the driving is possible (block 57-YES). It is to be noted that, whether there is available capacity for supplying the electric power to the other apparatus (data storage apparatus 1) is determined (block 54) even when the own apparatus (viewing apparatus 101) is driven by the battery 118, whether the other apparatus is requesting the supply of the electric power (whether the other apparatus has a supply request) is determined (block 55) when the supply is possible (block 54-YES), and the electric power is supplied to the other apparatus (data storage apparatus 1) when the electric power can be supplied (blocks 54 to 56).

Additionally, when it is determined that the driving cannot be performed using the battery 118 of the viewing apparatus 101 (own apparatus) (block 57-No), whether the electric power can be received from the other apparatus (data storage apparatus 1) is determined (block 59). When the electric power can be received from the other apparatus in block 59 (block 59-YES), the electric power is received from the other apparatus (data storage apparatus 1) to effect the driving (block 5A). When the electric power cannot be received from the other apparatus in block 59 (block 59-NO), since there is no power supply for continuous driving, the operation is stopped (block 5B). It is to be noted that, although not clearly mentioned, there is an operation halt by a user's explicit operation as a matter of course.

As described above, in case of transferring data between the viewing apparatus (television set) 101 and the data storage apparatus 1 connected to the viewing apparatus 101 which are connected through the high-speed first communication module 116 (16) which has a large output (power consumption) and a high capacity and the second communication module 117 (17) which has a small output (power consumption) and is suitable for transmission of a relatively small amount of data in a relatively short range and reproducing data such as sound/video/text/still pictures held by the data storage apparatus 1, and in case that the regular power supply, e.g., the AC power supply or the external power supply cannot be used, the power supply module is switched to each emergency power supply (battery 118/18), and the communication module is switched to the second communication module (117/17) (having small power consumption), whereby a viewer (user) can use the viewing apparatus to view necessary information and data (which are minimum at that moment [a special case wherein the regular power supply cannot be used]).

Further, an operable (viewable) time can be extended to a maximum extent by interchanging (interchanging) a remaining capacity of the emergency power supply between the viewing apparatus 101 and the data storage apparatus 1.

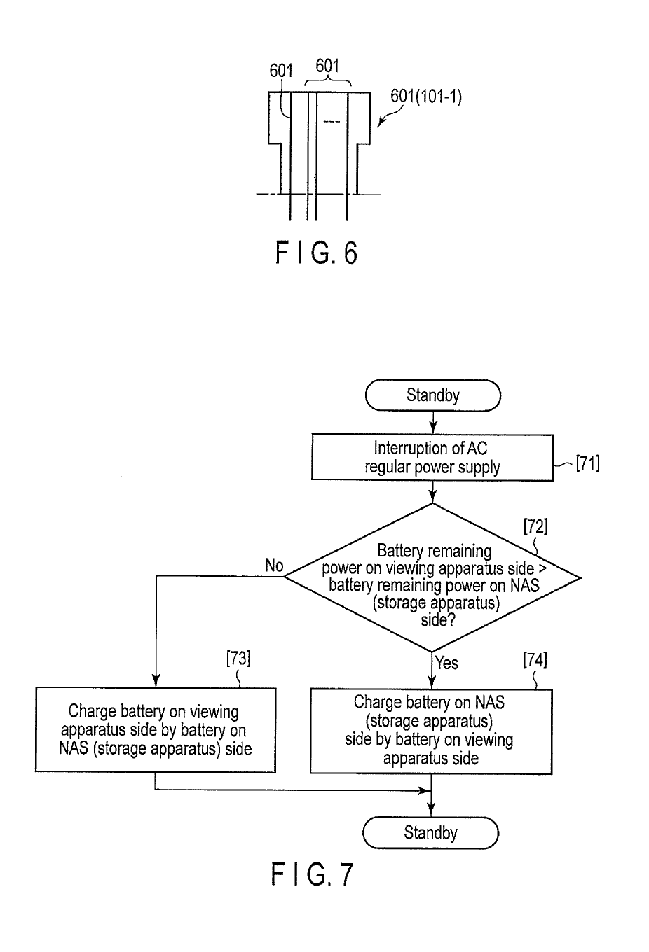

It is to be noted that, in regard to the interchange of the electric power, for example, two Universal Serial Bus (USB) cables are used as the power transmission path 101-1 connecting the power supply transmission/reception module 119 of the viewing apparatus 101 with the power supply transmission/reception module 19 of the data storage apparatus 1, and one of the USB cables can be used for the power transmission. Furthermore, as shown in FIG. 6, it is possible to use a cable (called USB-P for the sake of convenience) having a special form that a dedicated line for power transmission in which a data line group 601b and a power line 601p included in the usual USB cable are integrated in the same connector (package) is added.

Moreover, as shown in FIG. 7, in regard to electric charge (interchange of excess power) in the battery 118 on the viewing apparatus 101 side and the battery 18 on the data storage apparatus (NAS) 1 side, a remaining power amount in the battery 118 of the viewing apparatus 101 is compared with a remaining power amount in the battery 18 of the data storage apparatus 1 (block 72) at the time that interruption (off) of the AC (regular) power supply is detected (block 71), and the battery 18 of the data storage apparatus 1 is charged from the viewing apparatus 101 (block 74) when the battery 118 of the viewing apparatus 101 side has the larger remaining power amount (block 72-YES).

On the other hand, when the battery 18 of the data storage apparatus 1 has the larger remaining power amount (block 72-NO), the battery 118 of the viewing apparatus 101 is charged from the data storage apparatus 1 (block 73).

It is to be noted that, in both cases that the battery 118 of the viewing apparatus 101 side has a larger remaining power amount and that the battery 18 of the data storage apparatus 1 has a larger remaining power amount, the electric power to be interchanged is set in such a manner that the respective battery capacities become substantially equal in a remaining operating time. That is, when one of the batteries alone has the excess power (battery capacity) and the other (other party) cannot perform an operation, both the apparatuses cannot function, and hence interchange (of the electric power) is performed to enable prolonging the operable (viewable) time to a maximum extent.

Further, when the interruption (off) of the AC (regular) power supply has been detected (when a power outage has occurred), to reduce consumption of the battery remaining power amount to be interchanged, for example, the data storage apparatus 1 (or both the data storage apparatus 1 and the viewing apparatus 101) may be changed to a sleep mode with less power consumption. In this case, it is preferable to compare the electric power which is consumed in reboot (boot from the sleep mode) after elapse of a predetermined time, e.g., 10 minutes from last viewing using the viewing apparatus with the electric power which is consumed when the driving is continuously performed, and to change one of the apparatuses having a smaller amount (of the power consumption) to the sleep mode by priority.

Furthermore, when the interruption (off) of the AC (regular) power supply has been detected (when a power outage has occurred), periodically repeating on/off can be set. In this case, the on/off state of the data storage apparatus 1 can be set from the viewing apparatus 101. For example, the power supply transmission/reception module 119 of the viewing apparatus 101 and the power supply transmission/reception module 19 of the data storage apparatus 1 are turned on, and other elements are turned off, thereby further reducing the power consumption. Moreover, in regard to the communication path, suppressing the number of times (timing) for making reference to whether the first communication path 116/16 shown in FIG. 4 can be used enables further suppressing the power consumption.

It is to be noted that, when the interruption (off) of the AC (regular) power supply has been detected (when a power outage has occurred), a mode for display of the viewing apparatus 101 can be set as a mode having less power consumption with, e.g., suppressed brightness (luminance) or a reduced display region.

As described above, when the embodiment is applied, in viewing apparatuses that acquire and reproduce information based on the near field communication prepared as a second communication system if the external power supply (regular power supply) cannot be used due to, e.g., occurrence of a power outage, it is possible to provide the viewing apparatus and the viewing method that enable prolonged viewing (acquisition of information) even on the information providing (data storage apparatus connected to the viewing apparatus) side.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a display;
an emergency power supply module configured to supply electric power to the display at the time of interruption of a regular power supply;
a first communication module configured to perform communication based on a first standard;
a second communication module configured to perform communication based on a second standard having a capacity and a transmission speed that are lower than those of the first standard; and
a controller configured to drive the display using the emergency power supply module and to switch the communication using the first communication module to the communication using the second communication module when the regular power supply is interrupted.

2. The device of claim 1, wherein further comprising:
a power transmission path connected to the emergency power supply configured to interchange the electric power with a connected device on the other side.

3. The device of claim 2, wherein further comprising:
a power supply transmission/reception module configured to control the interchange of the electric power with the connected device on the other side through the power transmission path.

4. The device of claim 1, wherein the second communication module configured to acquire information held by the connected device on the other side.

5. The device of claim 2, wherein the second communication module configured to acquire information held by the connected device on the other side.

6. The device of claim 3, wherein the second communication module configured to acquire information held by the connected device on the other side.

7. An electronic device comprising:
a storage module configured to hold data;
an emergency power supply module configured to supply electric power if a regular power supply is interrupted;
a first communication module;
a second communication module having a capacity and a transmission speed lower than those of the first communication module; and
a controller configured to accept an instruction from a connected device on the other side and switches communication using the first communication module that utilizes the emergency power supply module as a power supply to communication using the second communication module if the regular power supply is interrupted.

8. The device of claim 7, wherein further comprising:
a power transmission path connected to the emergency power supply configured to interchange the electric power with a connected device on the other side.

9. The device of claim 8, wherein further comprising:
a power supply transmission/reception module configured to control the interchange of the electric power with the connected device on the other side through the power transmission path.

10. The device of claim 7, wherein the second communication module configured to provide the held information in response to a request from the connected device on the other side.

11. The device of claim 8, wherein the second communication module configured to provide the held information in response to a request from the connected device on the other side.

12. The device of claim 9, wherein the second communication module configured to provide the held information in response to a request from the connected device on the other side.

13. A driving method of an electronic device comprising:
detecting connection with a device on the other side having an emergency power supply;
detecting interruption of a regular power supply;
driving a display using the emergency power supply;
switching to a second communication system whose power consumption is smaller than that of a first communication system; and
using the second communication system to acquire information held by the device on the other side and displaying the acquired information in the display.

14. The method of claim 13, wherein an electric power of the emergency power supply is interchanged with the device on the other side through a power transmission path.

15. The method of claim 14, wherein the power transmission path is connected to power supply transmission/reception modules included in a viewing apparatus and the device on the other side, respectively.
